(19) United States
(12) Patent Application Publication
(10) Pub. No.: US 2015/0035677 A1
(43) Pub. Date: Feb. 5, 2015

(54) Bed Monitor Sensor Device

(71) Applicant: RONDISH COMPANY LIMITED, Kwai Chung (CN)

(72) Inventor: Steven Alfred Williams, Kwai Chung (CN)

(21) Appl. No.: 14/448,900

(22) Filed: Jul. 31, 2014

Related U.S. Application Data
(60) Provisional application No. 61/860,765, filed on Jul. 31, 2013.

(51) Int. Cl. G08B 21/02

(52) U.S. Cl. CPC G08B 21/02
USPC 340/573.1

(57) ABSTRACT

An infrared monitoring unit may include an infrared detector, a reset button, and a set-up light. The infrared detector may have a detection area that is sufficiently narrow to detect primarily the movement of a patient out of his or her bed. The detection area may be adjusted using a visible alignement beam eminating from a set-up light on the monitoring unit.

### CROSS-REFERENCE TO RELATED APPLICATION

This application claims priority to U.S. Provisional Patent Application No. 61/860,765, titled “Bed Monitor Sensor Device,” filed Jul. 31, 2013, the disclosure of which is hereby incorporated by reference herein.

### BACKGROUND

The present disclosure relates to systems, methods, and apparatuses for monitoring the status of a patient.

Patient monitoring systems are often based upon a wired connection between a sensor system, such as a bed-pad or floor mat, and a monitoring apparatus located either next to the patient or at times away from the patient, such as at a nurses' station. Traditionally bed-monitoring systems use pads placed under the patient. The pad is configured to detect when the patient leaves the bed by detecting the removal of weight on the pad. This way of performing this function is well established and is generally recognized as the industry standard.

However, there are several disadvantages to the use of monitoring pads. One such disadvantage is that the patient may move off the pad but still remain in the bed thereby causing a false alarm. Another disadvantage is that the cost of replacing pads can be quite high as the pads have a predetermined user life span, usually 1 year or less. In addition, the pads themselves can come in contact with the patient and therefore can be a hygiene risk. This is especially true when used with multiple patients. Another disadvantage is that the pads are not environmentally friendly as they must be disposed of after use and are therefore an environment hazard.

The use of passive infrared units (PIR) to sense patient movement is an alternative or supplement to the use of pads. PIR- based systems emit no light, but depend upon the radiation (i.e., heat) from objects or persons that enter the system's detection area or field. A drawback of a standard PIR-based system is that it will detect anyone moving within the area, and therefore the care worker or nurse will also set off the alarm. A passive infrared unit with a detection area that will capture the movement of a patient from a bed without detecting visitors, caregivers, or moving in the room could make PIR-based systems more desirable for use in patient monitoring.

### SUMMARY

Disclosed is a patient monitoring system that includes a passive infrared unit and a method of using the patient monitoring system. Provided in some embodiments is an infrared monitoring unit that includes an infrared detector, a set-up light, and a rest button. The infrared detector may be configured to detect radiation from persons or things that enter a detection area. The set-up light may be configured to emit an alignment beam of light.

The following features may be present in the infrared monitoring unit in any suitable combination. The detection area may be configured to define a narrow area about a patient be. The reset button may have more than one function in some embodiments. In such embodiments, the reset button may have at least one of the following functions: to reset the monitoring unit after entering an alarm condition, to enter a pause function, and to enter a set-up state. The set-up state may include activation of the set-up light. The pause function may include suppression of generation of any alarm signals.

In a related aspect, provided in some embodiments is a method of using an infrared monitoring unit that includes activating a set-up light on the infrared monitoring unit, aligning the infrared monitoring unit, and activating the infrared monitoring unit. The infrared monitoring unit may include an infrared detector, the set-up light, and a reset button.

The following features may be present in the method in any suitable combination. The infrared detector may be configured to detect radiation from persons or things that enter a detection area. The set-up light may be configured to emit an alignment beam of light. Activating the set-up light may include pressing the reset button. Aligning the infrared monitoring unit may include rotating the infrared monitoring unit about a swivel head. Additionally, or alternatively, aligning the infrared monitoring unit may include moving the infrared monitoring unit until an alignment beam from the set-up light indicates that the furthest point of a desired detection area of the infrared detector.

Other features and advantages should be apparent from the following description of various embodiments, which illustrate, by way of example, the principles of the disclosure.

### BRIEF DESCRIPTION OF THE DRAWINGS

FIG. 1 shows an exemplary patient monitoring unit.

FIGS. 2A and 2B show different embodiments of a patient monitoring unit and a wall coupling mechanism.

FIG. 3 shows a pair of patient monitoring units in a set-up configuration.

FIG. 4 shows a pair of patient monitoring units in use, mounted on a wall behind a patient bed.

FIG. 5 shows a pair of patient monitoring units in use, mounted on floor stands beside a patient bed.

FIG. 6 shows an exemplary setup procedure for the patient monitoring unit.

### DETAILED DESCRIPTION

Disclosed is a passive infrared (PIR) monitoring unit that can be positioned adjacent a patient's bed. The monitoring unit outputs a detection signal with a narrow detection angle that is configured to avoid false alarms. The monitoring unit outputs a pointer beam (such as a red beam) to allow easy adjustment and set-up for the care worker to easily set the coverage area. The monitoring unit includes a reset button that deploys the pointer beam for a predetermined time period to allow adjustment of the monitoring unit.

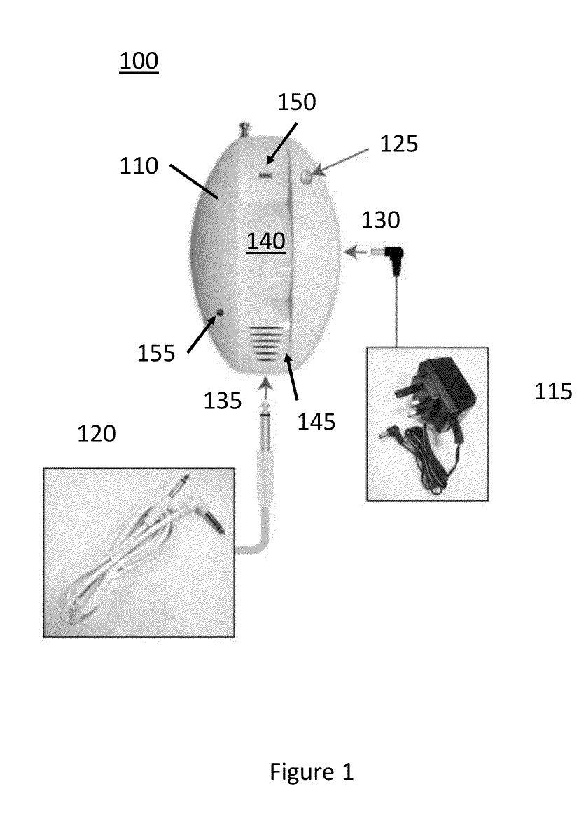

FIG. 1 shows a front view 100 of an exemplary monitoring unit 110. The monitoring unit 110 is sized and shaped to be mounted adjacent a patient's bed, such as on a wall. The monitoring unit 110 may have a power source 115, a wired connection to a patient monitoring system 120, a reset button 125, an inlet for power 130, a connection point for a patient monitoring system 135, a speaker for audible alarms or notifications 145, an infrared (IR) detector 140, an indicator light 150, and an alignment LED 155.

The infrared detector 140 may include one or more sensors that generate an electrical current or signal in response to detected radiation. The detected radiation may be dependent on the temperature of an object. The temperature sensor or sensors may be solid-state sensors, including solid state sensors that include pyroelectric materials. The temperature sensor(s) may include thin film materials. Materials from which the temperature sensor(s) may be made include gallium nitride (GaN), caesium nitrate (CsNO3), polyvinyl fluorides, derivatives of phenylpyridine, and cobalt phthalocyanine. One or more integrated circuits can be connected to or part of the infrared detector 140.

Additionally, one or more lenses or mirrors, or a combination of one or more lenses and mirrors may be part of the infrared detector 140. The lenses, mirrors, or combination thereof, may be selected to create a sufficiently narrow area of detection. That is to say, that the combination of lenses and/or mirrors allows the system to detect the temperature of objects (e.g., persons) in a specific, and particularly narrow, portion of a room. This specific, and particularly narrow, portion of a patient's room is the area of detection for the infrared detector 140. This area of detection is invisible to the human eye when infrared detector 140 is in use because the detector does not generate light to excite radiation from objects. The temperature (i.e., radiation) detected from the objects in the area of detection is translated into an electrical signal that is processed. The processed signal may be used to determine an alarm state, such as when a patient moves out of bed. The detection area may span an area of about 6 inches (15 cm) in width or less, such as about 4 inches (10 cm) in width or less, including about 3 inches (7.5 cm) in width or less, about 2 inches (5 cm) in width or less, and about 1 inches (2.5 cm) or less. Alternatively, or additionally, the detection area may span an area corresponding to about 15° or smaller, such as about 10° or less, including about 5° or less, such as about 2.5 or less, or about 1° or less.

The electrical signal produced by the IR detector 140 may be processed in the monitoring unit 110. Alternatively, or additionally, the monitoring unit 110, may send the electrical signal produced by the IR detector 140 to a monitoring system, such as a nurse-call station or bedside patient monitor through a wired connection 120 or through a wireless connection. The monitoring unit 110 may include one or more mechanisms that trigger an alarm, when the electrical signal from the IR detector 140 is processed in the monitoring unit 110. When an alarm condition is determined, the monitoring unit 110 can indicate that through the indicator light 150, speaker 145, or both the indicator light 150 and the speaker 145. The alarm condition may be determined by the monitoring unit 110, or a signal indicating an alarm condition may be received from an external source. An external source that may signal an alarm condition may include a bedside patient monitor that has processed the electrical signal produced by the IR detector, either through a wired connection 120 or through a wireless connection.

The reset button 125 is positioned on the monitoring unit so the care worker can easily press it without triggering the detector. In an embodiment, the reset button 125 has at least two functions: (1) to allow the care worker to reset the monitoring unit 110 after an alarm; and (2) to allow the care worker to access the bed when the monitoring unit 110 is active. In this case if the reset button 125 is pressed the unit 110 will enter a pause mode, which will allow the care worker to access the bed. While triggering the infrared detector 140, a pause timer will be reset up to a maximum time period (such as, for example, 3 minutes) after which time the alarm will again be activated. Pressing the reset again will reset the pause. After the care worker leaves the bed and the infrared detector 140 is no longer triggered, the pause feature will time out within a time period, such as 15 seconds for example. During the pause feature the indicator light 150 will blink and an optional periodic beep sound will indicate the unit is in pause mode.

The reset button 125 may activate the set-up light 155 so that a user can position the monitoring unit 110 to detect the movement of a patient out of bed. For example, pressing and holding the reset button 125, or pressing the reset button 125 in a certain sequence, can turn on the set-up light 155. The set-up light may be a light emitting diode (LED) or laser that produces a beam of visible light. The beam of visible light gives the user an idea of the detection area of the IR-detector 140.

In an embodiment, the monitoring unit 110 can send a wireless signal to another monitoring unit or to a patient monitoring system. The other monitoring unit or patient monitoring system may be nearby or outside the patient's room. The other unit or patient monitoring system may include a cord free bed monitor, a simple receiving doorbell type alarm, a nurse-call system, a patient monitoring system with multiple detection systems and a central alarm and signaling system, and the like. The wireless signal of the monitoring unit 110 may be monitored to check that it is working correctly, for example by the other monitoring unit or patient monitoring system sending a signal to the monitoring unit 110 that requires a response. Such a pinging signal may trigger an alarm condition, and in turn alarm signal, if there is no response.

An alarm signal can be produced after an alarm condition is triggered. An alarm condition may include an interruption of the communication between the monitoring unit 110 and components of a larger patient monitoring system, as discussed above. The patient leaving the confines of his or her bed may also trigger an alarm condition. Other components of the larger patient monitoring system may give rise to the triggering of an alarm condition, such as detection of changes in the patient's clinical condition.

The alarm signal can be an audio signal, a visual signal, or both an audio and visual signal. An audio signal can be a sustained sound, an instantaneous sound, and/or a repeating sound. A visual signal can be a flashing light, an indicator light, a message on a user interface, or any combination thereof. A message can be a message on a user interface, a message sent to an external device, or an audio message. A message can also be an audio telephonic message sent to a land-line, a mobile phone, or a voice-mail account. Additionally, a message can be a text-based or icon based message, such as a short message service message (i.e. SMS text message), an e-mail, or a multimedia messaging service message received on a mobile phone, pager, or hand-held device that is configured to send and receive data using cellular phone signaling means.

The larger patient monitoring system, including the monitoring unit 110, may be communicatively coupled to a Personal Emergency Alarm System (PERS) for on-site assisted living accommodation, to a nurses' station or off-site alarm relay via the telephone network or internet, to alert family, friends, caregivers, control centers, or any combination thereof. In such cases, when an alarm condition triggers, any of those systems or persons may receive an alarm signal.

The monitoring unit 110 may include an internal speaker 145 with adjustable volume as well as an indicator light 150, such as a light emitting diode (LED) indicator that may be a high brightness LED. The internal speaker 145 may sound when the alarm signal includes an audio signal. The indicator light 150 activate when the alarm signal includes a visual signal. The alarm signal may be sent or received by the monitoring unit through the 120 wired connection, for example a connection to a larger patient monitoring system or a bedside patient monitoring system, or through wireless signaling. Wireless signaling can utilize any suitable wireless technology, such as Bluetooth, WiFi, radio frequency, Zigbee communication protocols, infrared, cellular phone systems, and the like, and can also employ coding or authentication to verify the origin of the information received by either or both the monitoring unit 110 and the larger patient monitoring system.

The monitoring unit 110 may be powered via an AC or DC power configuration 115 and may include rechargeable batteries. Alternatively, or additionally, the monitoring unit 110 may be powered by a connection directly into the room's power, without the need of plugging the monitoring unit 110 into a socket or electrical outlet.

One or more communication and/or power cables may be attached to the unit. In embodiment, the unit includes a detector configured to detect if a cable is attached or detached from the unit. The detector may trigger an alarm condition, and in turn an alarm signal, upon such occurrence.

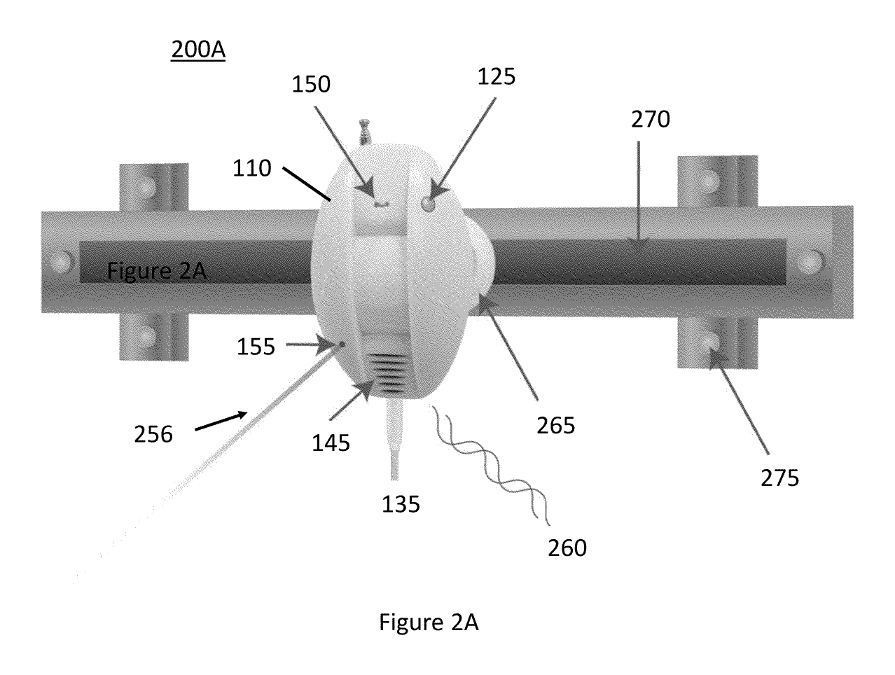

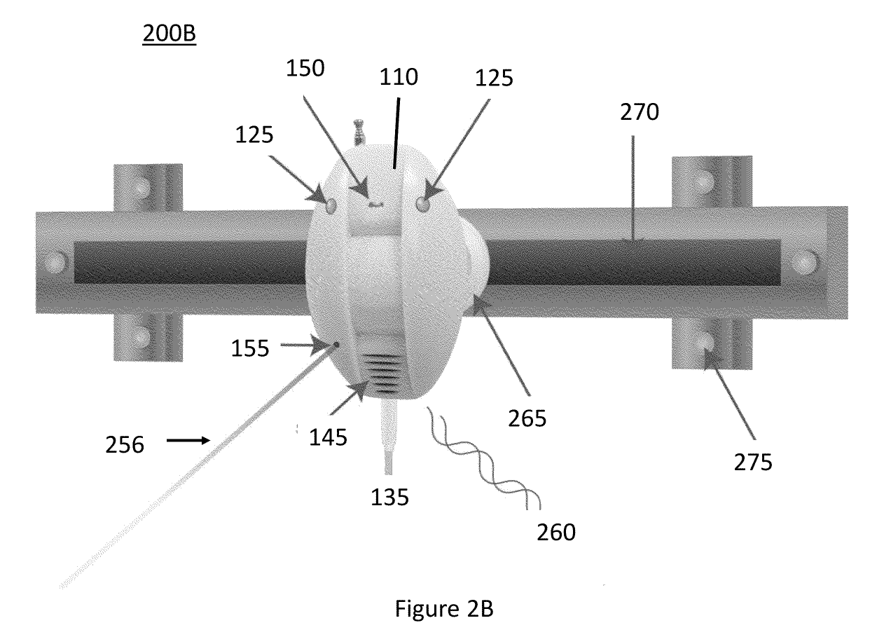

In some embodiments, the monitoring unit 110 is movably attached to a bracket or stand. FIG. 2 shows a configuration 200A of the monitoring unit 110 attached to a slide bracket 270. In this configuration 200A, a swivel head 265 may be used to attach the monitoring unit 110 to the bracket or stand 270 and permit further adjustment of the unit's orientation. As in FIG. 1, the monitoring unit 110 has a reset button 125, a connection point for a patient monitoring system 135, a speaker for audible alarms or notifications 145, an infrared (IR) detector 140, an indicator light 150, and an alignment (or set-up) LED 155. In FIG. 2, the monitoring unit 110, is shown as further having a wireless connection 260 to a larger patient monitoring system or to another monitoring unit, as well as emitting an alignment beam from the set-up light 155. As mentioned above, in FIG. 2, the monitoring unit 110 is attached to a swivel head 265. This swivel head 265 may be a connector to a bracket, such as the slide bracket 270 shown in FIG. 2. The slide bracket 270 may have more than one mounting fixtures 275 to affix the slide bracket to a wall or other flat surface. The monitoring unit 110 may slide along a slot or rail in the slide bracket, and thus the position of the monitoring unit 110, and in turn its detection area, may adjust in a linear manner. This linear adjustment, in conjunction with the pivotal adjustment possible using the swivel head 265, may allow for positioning monitoring unit 110 and in turn the detection area suitably near the patient and away from the movement of other people in the patient's room away from the patient's bed.

FIG. 2B shows a different embodiment of a configuration 200B of a monitoring unit 110 mounted on a slide bracket 270. The slide bracket 270 is similar to that shown in FIG. 2A. The monitoring unit 110 has all the features of the monitoring unit 110 of FIG. 2A, but with the added feature of a second reset button 125. The first reset button and the second reset button 125 are placed symmetrically at the top of the monitoring unit 110 about a centerline of the unit. Such a configuration 200B of the monitoring unit 110 may allow for easier access to the reset button 125, and in turn easier activation of the pause function or the alignment function described above.

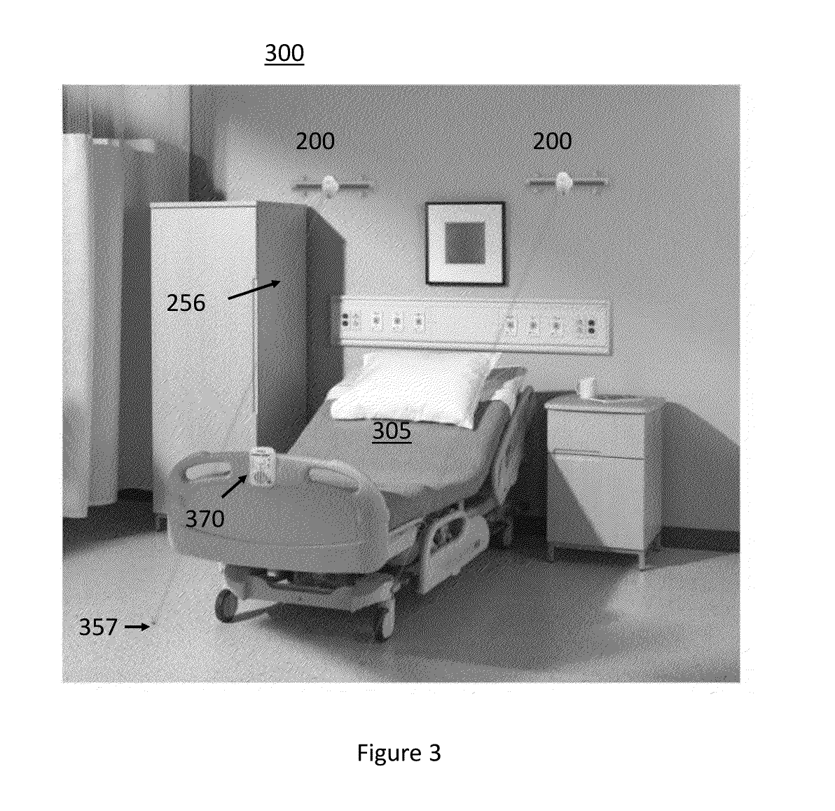

A set-up configuration 300 of two monitoring units, each on a slide bracket, 200 mounted on the wall behind a patient's bed 305 is shown in FIG. 3. From each monitoring unit, an alignment beam 256 shines onto the floor. Each alignment beam 256 shows the furthest point away 356 from the wall that the corresponding IR detector (140 in FIG. 1) can detect in its detection area. The distance between an edge of the bed 305 and the point 356 indicates the proximity of the detection area to the bed 305. As described above, this set-up configuration 300 may result from pressing the reset button (125 in FIG. 1) in a certain pattern or manner.

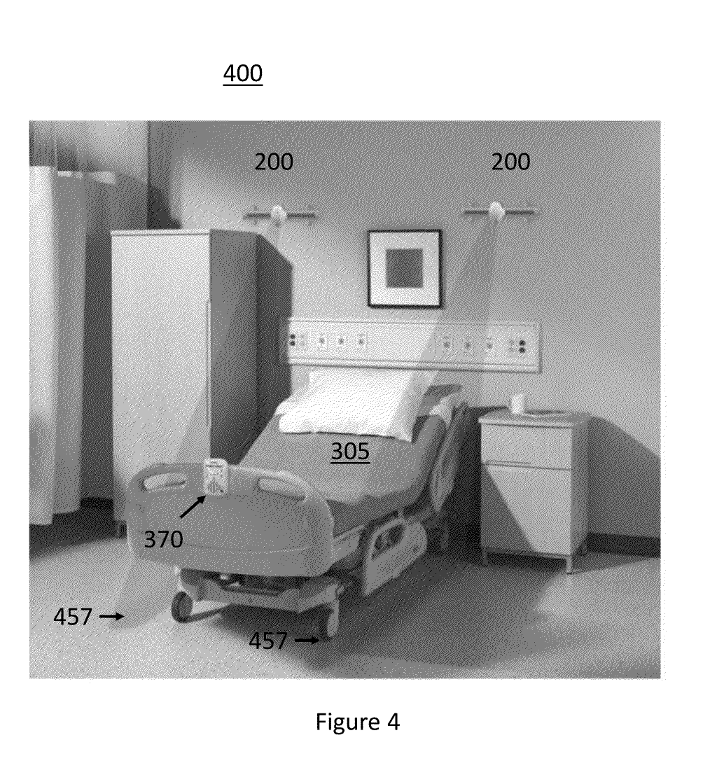

FIG. 4 shows two monitoring units, each on a slide bracket, 200 mounted on the wall behind a patient's bed 305 in a use configuration 400. This configuration may actively monitor the movements of a patient from his or her bed 305. The detection area 457 is visible in FIG. 4, however, it should be understood that the detection area 457 may not be visible, as the monitoring unit 110 may not emit light when in a use configuration or mode. The detection area 457 in FIG. 4 may be for illustration purposes only, to show the areas surrounding the bed 305 which will trigger an alarm condition should a person enter into those areas. A bedside patient monitor 370 is at the foot of the patient's bed 305. The bedside patient monitor 370 may communicate with each of the monitoring units 110 through a wired or wireless connection, and additionally, the bedside patient monitor 370 may be part of a larger patient monitoring system.

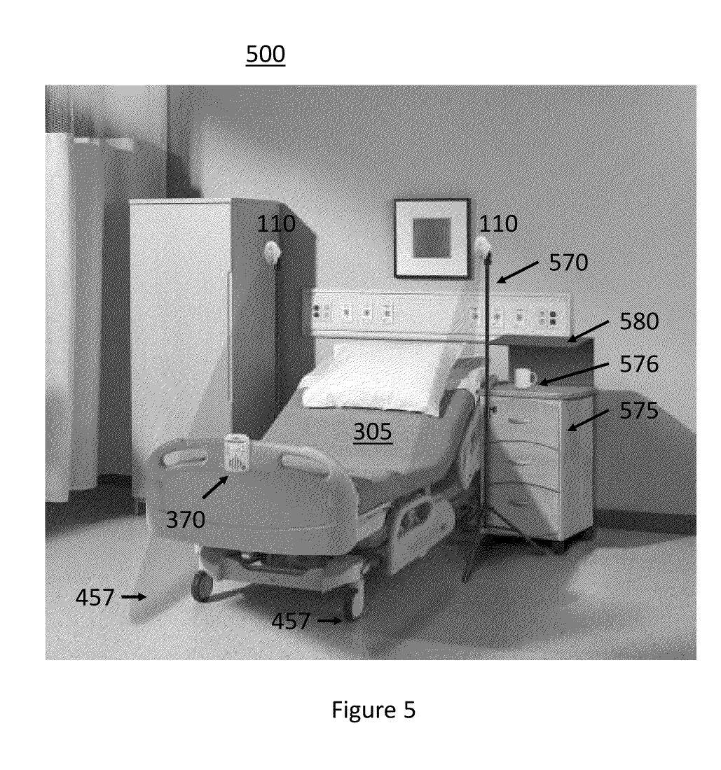

A variation of a use configuration 500 is shown in FIG. 5. As in the use configuration shown in FIG. 4, there is a patient bed 305 with a monitoring unit 110 on either side of the bed 305. At the foot of the bed is a bedside patient monitor 370, and the detection area 457 encompassed by each monitoring unit 110 is shown for illustrative purposes. Each monitoring unit 110 is situated atop a floor stand 570. Each monitoring unit 110 may attach to a corresponding floor stand 570 using a swivel head 265. A user may use each floor stand 570 and may pivot each monitoring unit 110 about a corresponding swivel head 265 to adjust the detection area 457. By having one or both monitoring units 110 atop a floor stand 570, a patient or caregiver can reach between an area at the head of the bed and an area adjacent the head of bed. For example, a patient in the bed 305 may reach behind the floor stand 570 to the top of a bedside table 575 to reach a cup 576. A patient guide 580 may be present to encourage the patient to keep his or her hand and arm below a certain height, ensuring it does not enter the detection area 457.

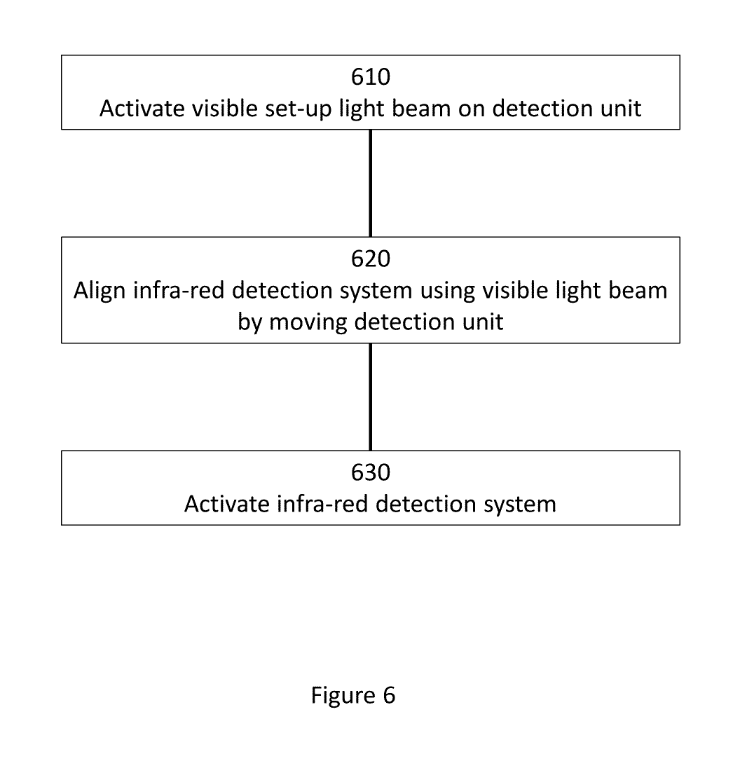

FIG. 6 shows a method for using a monitoring unit 110 to monitor a patient. When using the monitoring unit 110, the set-up light is activated, as in 610 and as shown in FIG. 3. The monitoring unit 110 in the infra-red detection system is aligned by moving the unit 110, as in 610 and described above. Once the detection area has been positioned and the infrared detection system is aligned, the monitoring unit 110, and the larger patient monitoring system, may be activated, as in 630.

Though the methods, apparatus, and systems described above are with respect to a patient in a bed, they may apply to a patient in any position from which he or she should not move without assistance. Such positions may include seated in a seat or wheelchair, reclining on a sofa, and the like.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, methods of use, embodiments, and combinations thereof are also possible. Therefore the spirit and scope of the appended claims should not be limited to the description of the embodiments contained herein.

What is claimed is:

1. An infrared monitoring unit comprising:
an infrared detector configured to detect radiation from persons or things that enter a detection area;
a set-up light configured to emit an alignment beam of light; and
a reset button.

2. The infrared monitoring unit of claim 1, wherein the detection area is configured to define a narrow area about a patient bed.

3. The infrared monitoring unit of claim 1, wherein the reset button has more than one function.

4. The infrared monitoring unit of claim 3, wherein the reset button has at least one of the following functions:
to reset the monitoring unit after entering an alarm condition;
to enter a pause function; and
to enter a set-up state.

5. The infrared monitoring unit of claim 4, wherein the set-up state comprises activation of the set-up light.

6. The infrared monitoring unit of claim 4, wherein the pause function comprises supression of generation of any alarm signals.

7. A method of using an infrared monitoring unit comprising:
activating a set-up light on the infrared monitoring unit;
aligning the infrared monitoring unit; and
activating the infrared monitoring unit,
wherein the infrared monitoring unit comprises:
an infrared detector;
the set-up light; and
a reset button.

8. The method of claim 7, wherein activating the set-up light comprises pressing the reset button.

9. The method of claim 7, wherein aligning the infrared monitoring unit comprises rotating the infrared monitoring unit about a swivel head.

10. The method of claim 7, wherein aligning the infrared monitoring unit comprises moving the infrared monitoring unit until an alignment beam from the set-up light indicates the furthest point of a desired detection area of the infrared detector.

11. The method of claim 7, wherein the set-up light is configured to emit an alignment beam of light.
